(19) United States
(12) Patent Application Publication
(10) Pub. No.: US 2026/0058330 A1
(43) Pub. Date: Feb. 26, 2026

(54) Current Collector for Secondary Batteries, Secondary Battery Including the Same, and Method of Manufacturing Current Collector for Secondary Batteries

(71) Applicant: LG Energy Solution, Ltd., Seoul (KR)

(72) Inventors: Jin Uk Do, Daejeon (KR); Jin Sub Park, Daejeon (KR)

(73) Assignee: LG Energy Solution, Ltd., Seoul (KR)

(21) Appl. No.: 19/296,374

(22) Filed: Aug. 11, 2025

(30) Foreign Application Priority Data
Aug. 21, 2024 (KR) 10-2024-0112190
Oct. 28, 2024 (KR) 10-2024-0149042
Aug. 11, 2025 (KR) 10-2025-0110878

(51) Int. Cl. H01M 50/533; H01M 50/176; H01M 50/55; H01M 50/586; H01M 50/59

(52) U.S. Cl. CPC H01M 50/533; H01M 50/176; H01M 50/55; H01M 50/586; H01M 50/59

(57) ABSTRACT

A current collector for secondary batteries includes at least two electrically conductive current collecting plate members at least partially received in respective recessed regions spaced apart from one another in an electrically insulating substrate. Different interfaces may be provided between the plate members and the substrate. The plate members may be secured to the substrate by adhesive or by insert injection molding when the substrate is formed. A secondary battery including such a current collector has a casing, an electrode assembly, and a cap assembly, where groups of tabs of the electrode assembly are electrically coupled to the current collecting plate members, which are in turn electrically coupled to opposite polarity terminals of the cap.

### CROSS-REFERENCE TO RELATED APPLICATIONS

The present application claims priority to and the benefit of Korean Patent Application Nos. 10-2024-0112190, 10-2024-0149042, and 10-2025-0110878, respectively filed on Aug. 21, 2024, Oct. 28, 2024, and Aug. 11, 2025, in the Korean Intellectual Property Office, the entire disclosures of which are incorporated herein by reference.

### TECHNICAL FIELD

The present disclosure relates to a current collector for secondary battery, a secondary battery including the current collector, and a method of manufacturing a current collector for secondary batteries.

### BACKGROUND

Recently, as the demand for portable electronic devices such as notebook computers, video cameras, and mobile phones has rapidly increased and the development of electric vehicles, energy storage batteries, robots, satellites, and the like has been actively promoted, intensive research has been conducted on high-performance secondary batteries capable of repeated charging and discharging.

Currently commercialized secondary batteries include nickel-cadmium batteries, nickel-metal hydride batteries, nickel-zinc batteries, lithium secondary batteries, and the like. Among the secondary batteries listed above, lithium secondary batteries are attracting attention due to advantages such as allowing flexible charging and discharging owing to negligible memory effect compared to nickel-based secondary batteries, exhibiting a significantly low self-discharge rate, and having a relatively high energy density.

Such lithium secondary batteries mainly use a lithium-based oxide and a carbon material as a positive electrode active material and a negative electrode active material, respectively. In addition, the lithium secondary battery includes a positive electrode plate and a negative electrode plate on which the positive electrode active material and the negative electrode active material are respectively applied, an electrode assembly in which the positive electrode plate and the negative electrode plate are located with a separator interposed therebetween, and an external housing that seals and accommodates the electrode assembly together with an electrolyte.

Lithium secondary batteries may be classified, according to the shape of a battery casing, into a can-type secondary battery, in which an electrode assembly is embedded in a metal can, and a pouch-type secondary battery, in which an electrode assembly is embedded in a pouch formed of an aluminum laminate sheet. The can-type secondary battery may also be classified into a cylindrical secondary battery and a prismatic secondary battery according to the shape of the metal can.

The prismatic secondary battery is subjected to a process including gathering a plurality of electrically conductive thin film tabs connected to electrode plates into a single group, pre-welding the group of collected thin film tabs, and then welding the pre-welded thin film tabs to a current collection component. The current collection component to which the thin film tabs are welded is connected to a terminal of a cap assembly.

A positive electrode current collection component and a negative electrode current collection component are individually coupled to the cap assembly. However, if even one of the respective current collection components is not aligned with a coupling position of the cap assembly, it is difficult to connect the current collection component to the corresponding terminal. In such a case, since the current collection component is already welded to the thin film tabs, it can be difficult to correct the coupling position, resulting in reduced assemblability with the cap assembly.

### SUMMARY

To solve the above problems, an object of at least some aspects of the present disclosure is to provide a current collector for secondary batteries, in which a current collection component has an integrated structure to improve assemblability with a cap assembly, and a secondary battery including the current collector. Not all aspects of the present disclosure must satisfy that object, however.

A current collector for secondary batteries according to an aspect of the present disclosure may include an electrically insulating substrate as well as electrically conductive first and second current collecting plate members at least partially received in respective first and second recessed regions spaced apart from one another in a lateral dimension of the substrate. The first and second recessed regions may be recessed downwardly in a vertical dimension from an upper side of the substrate so as to define a respective side face of each recessed region. A side edge surface of each of the current collecting plate members (in a thickness dimension thereof) may abut the side face of the respective recessed region. The first and second current collecting plate members may also be coupled to respective first and second connection terminals that extend away from the respective current collecting plate member.

The substrate may include an intermediate portion that extends between the first and second side faces of the respective first and second recessed regions. The upper side of the substrate in the intermediate region may be flush with an upper side of each of the current collecting plate members. The substrate may include first and second portions extending underneath the respective first and second current collecting plate members. The first and second portions may be monolithically formed as a single piece of electrically insulating material with the intermediate portion of the substrate. The upper side of the substrate in the intermediate portion may have opposing first and second edges that extend along the lateral dimension, where each of the first and second edges defines a respective plane inclined obliquely relative to the vertical dimension.

The substrate may be elongated along the lateral dimension such that the substrate extends along a longitudinal axis that extends between and connects the first and second current collecting plate members. The current collecting plate members may each have a planar shape. The first and second connection terminals may extend upwardly along the vertical dimension from an upper side of the respective first and second current collecting plate members.

In one aspect, the side edge surface of each current collecting plate member may abut the side face of the respective recessed region to define a respective plane inclined obliquely relative to the vertical dimension. In another alternative aspect, the side edge surface of each current collecting plate member may abut the side face of the respective recessed region to define a respective concave/concave mating interface.

The substrate may include first and second open regions where the substrate does not extend below the respective first and second current collecting plate member so as to expose corresponding portions of an underside of the current collecting plate member.

Each current collecting plate member has opposing first and second sides extending along the lateral dimension, and a first and second cutout may be defined along the respective first and second sides, each cutout extending into the respective side of the respective current collecting plate member towards the opposite side. In some aspects, the first and second cutouts may be offset from one another along the lateral dimension.

The substrate may include first and second securement extensions extending downwardly from opposing sides of the substrate so as to securely engage opposing sides of an electrode assembly therebetween. In some aspects, the first and second securement extensions may be positioned at diagonally opposing corners of the substrate, with each of the securement extensions being configured to securely engage both a respective one of the opposing side surfaces of the electrode assembly and a respective adjoining side surface at a respective corner of the electrode assembly.

Another aspect of the disclosure provides a secondary battery. The secondary battery may include a casing, an electrode assembly positioned within the casing, a cap assembly positioned above the electrode assembly and enclosing the casing, and a current collector in accordance with any of the aspects of the disclosure, the current collector being positioned within the casing above the electrode assembly and below the cap assembly. The electrode assembly may include a plurality of electrode tabs electrically coupled to respective electrodes of the electrode assembly, where the plurality of tabs may extend upwardly from the electrode assembly. A first group of the plurality of tabs having a first polarity may be electrically coupled to the first current collecting plate of the current collector, and a second group of the plurality of tabs having a second polarity may be electrically coupled to the second current collecting plate of the current collector. The first and second connection terminals of the respective first and second current collecting plate members may be electrically coupled to respective first and second terminals of the cap assembly.

The cap assembly may include a cap plate having a first terminal hole and a second terminal hole, where the first and second connection terminals each extend within the respective first and second terminal hole so as to electrically couple with the respective first and second terminal of the cap assembly. The first and second groups of tabs may be coupled to the upper side of the respective first and second current collecting plate member in a respective coupling region that is spaced from the respective first and second connection terminal in the lateral dimension.

Another aspect of the disclosure provides a method of manufacturing a current collector for secondary batteries. The method may include securing electrically conductive first and second current collecting plate members to a substrate formed of an electrically insulating material such that the first and second current collecting plate members are at least partially received in respective first and second recessed regions of the substrate and such that side edge surfaces of the first and second current collecting plate members in a thickness dimension thereof abut respective first and second side faces of the respective first and second recessed regions. The first and second recessed regions may be spaced apart from one another in a lateral dimension of the substrate. Moreover, each of the first and second recessed regions may be recessed downwardly in a vertical dimension from an upper side of the substrate so as to define the respective first and second side faces.

In one aspect, the step of securing the first and second current collecting plate members to the substrate may include affixing the first and second current collecting plate members to the substrate by an adhesive. In another alternative aspect, the step of securing the first and second current collecting plate members to the substrate may include injection molding the electrically insulating material of the substrate within a mold in which the first and second current collecting plate members are received.

### BRIEF DESCRIPTION OF THE DRAWINGS

The following drawings attached to this specification illustrate preferred aspects of the present disclosure, and help to further understand the technical spirit of the present disclosure along with the aforementioned contents of the disclosure. Accordingly, the present disclosure should not be construed as being limited to only contents described in such drawings.

FIG. 1 is a perspective view illustrating a secondary battery according to a first aspect of the present disclosure.

FIG. 2 is a perspective view of a partially exploded configuration of the secondary battery of FIG. 1.

FIG. 3 is a perspective view of a current collector for secondary batteries.

FIG. 4 is a perspective view illustrating the current collector for secondary batteries and a cap assembly together.

FIG. 5 is a front elevation view illustrating the current collector for secondary batteries.

FIGS. 6A-6C are front elevation views of modified examples of a current collector for secondary batteries, illustrating different intermediate connection portions.

FIG. 7A is a schematic top plan view of a portion of a current collector for secondary batteries, illustrating a first current collection component and a first wing portion.

FIG. 7B is a front elevation view of the portion of the current collector illustrated in FIG. 7A.

FIG. 8 is a perspective view illustrating electrode tabs coupled to the current collector for secondary batteries.

FIGS. 9A to 9B are a schematic top plan view and front elevation view, respectively, of a portion of a current collector for secondary batteries, illustrating an alternative example of a first wing portion.

FIG. 10 is a schematic top plan view of a portion of a current collector for secondary batteries, illustrating another alternative example of a first wing portion.

FIGS. 11A to 11B are a schematic top plan view and front elevation view, respectively, of a portion of a current collector for secondary batteries, illustrating another alternative example of a first wing portion.

FIG. 12 is an enlarged perspective view of a portion of a current collector of a secondary battery according to a second aspect of the present disclosure.

FIG. 13 is a top plan view of the portion of the current collector of FIG. 12.

FIG. 14 is a top plan view of a portion of a current collector of a secondary battery illustrating a modified example of a first current collection component of FIG. 13.

FIG. 15 is a perspective view illustrating a current collector for secondary batteries and a cap assembly according to a third aspect of the present disclosure.

FIG. 16 is a schematic top plan view illustrating the current collector for secondary batteries of FIG. 15.

FIGS. 17A-17C are schematic top plan views of modified examples of a current collector for secondary batteries, illustrating different fastening rods.

FIG. 18 is a perspective view of a partially exploded configuration of a secondary battery, illustrating a current collector and a cap assembly according to a fourth aspect of the present disclosure.

FIG. 19 is a perspective view of a partially exploded configuration of a secondary battery, illustrating a current collector and a cap assembly according to a fifth aspect of the present disclosure.

FIG. 20 is a perspective view of a partially exploded configuration of a secondary battery, illustrating a current collector and a cap assembly according to a sixth aspect of the present disclosure.

FIG. 21 is a schematic cross-sectional side view of a portion of the current collector and cap assembly of FIG. 20.

FIG. 22 is a flowchart of a method of manufacturing a current collector provided in a secondary battery according to a seventh aspect of the present disclosure.

FIG. 23 is a perspective schematic view of a current collector of a secondary battery, illustrating a coupling operation.

FIG. 24 includes schematic side cross-sectional views of steps of a coupling operation.

FIG. 25 is a perspective view of a battery module including a plurality of secondary batteries according to FIG. 1.

FIG. 26 is a perspective exploded view of a battery pack including a plurality of battery modules according to FIG. 25.

### DETAILED DESCRIPTION

Since the present disclosure may be modified in various forms, and may have various aspects, particular aspects will be illustrated in the accompanying drawings and described in detail with reference to the drawings. However, this is not intended to limit the present disclosure to particular modes of practice, and it is to be appreciated that all changes, equivalents, and substitutes that do not depart from the spirit and technical scope of the present disclosure are encompassed in the present disclosure.

The terminology used herein is for the purpose of describing particular aspects only and is not intended to be limiting the present disclosure. In the present disclosure, the singular forms are intended to include the plural forms as well, unless the context clearly indicates otherwise. It will be further understood that the terms “comprise,” “include,” “have,” etc., when used in this specification, are intended to specify the presence of stated features, integers, steps, operations, elements, components, and/or combinations of them but do not preclude the presence or addition of one or more other features, integers, steps, operations, elements, components, and/or combinations thereof.

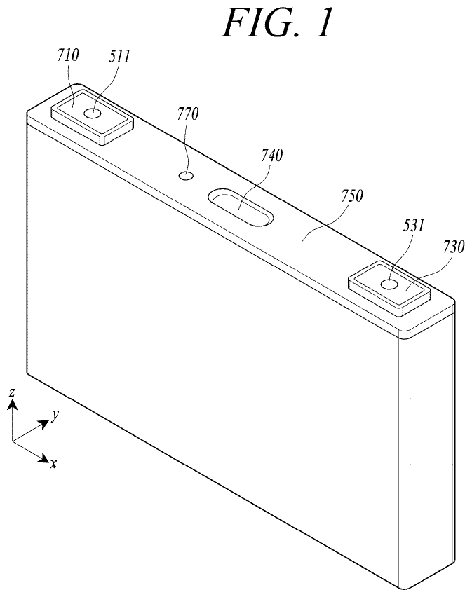

In the present specification, the term “longitudinal dimension” refers to an x-axis dimension in FIG. 1, the term “width dimension” refers to a y-axis dimension in FIG. 1, and the term “height dimension” or “vertical dimension” refer to a z-axis dimension in FIG. 1. With the z-axis dimension being defined as the “vertical dimension,” the x-axis dimension and the y-axis dimension may both be characterized as “lateral dimensions,” i.e., they extend to the side of the vertical dimension in a plane (the x-y plane) that is oriented orthogonally to the z-axis. It is noted that, as used herein (including in the claims), the various dimensions are not to be limited to having particular orientations with respect to a gravitational frame of reference, but rather the dimensions are labeled for convenience in distinguishing different directions relative to one another. For example, a “lateral dimension” is characterized by being orthogonal to the “vertical dimension,” regardless of whether the “vertical dimension” is actually aligned in an upward/downward direction aligned with the direction of gravity. Thus, terms such as “vertical dimension,” “downwardly,” “upper,” etc. are not to be interpreted as being limited to a particular orientation with respect to the direction of gravity.

Hereinafter, aspects of the present disclosure will be described in detail with reference to the accompanying drawings. It should be noted that like reference numerals refer to like elements throughout the attached drawings. Details of well-known configurations and functions may be omitted to avoid unnecessarily obscuring the gist of the present disclosure. For the same reason, in the accompanying drawings, some elements are enlarged, omitted, or depicted schematically.

Hereinafter, a secondary battery according to a first aspect of the present disclosure will be described.

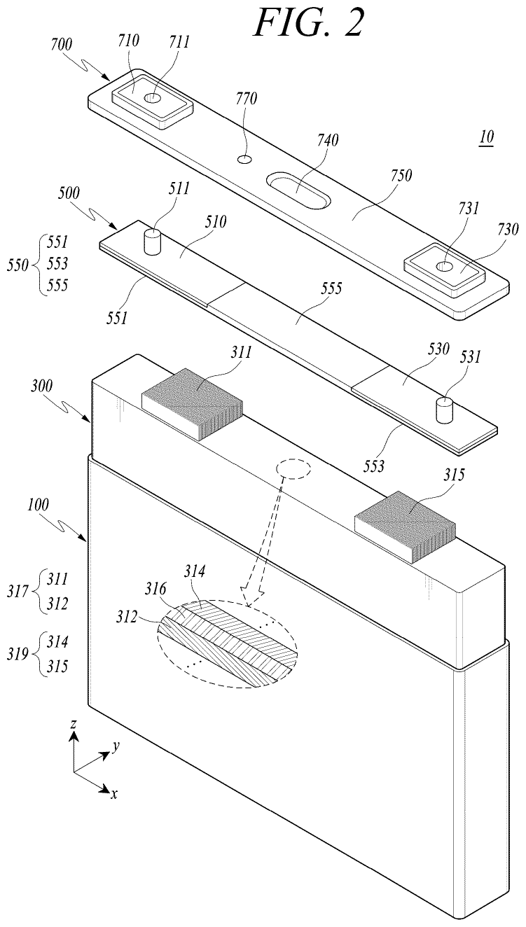

FIG. 1 is a perspective view illustrating the secondary battery according to the first aspect of the present disclosure. FIG. 2 is a perspective view of a partially exploded configuration of the secondary battery of FIG. 1.

Referring to FIGS. 1 and 2, the secondary battery 10 according to the first aspect of the present disclosure includes an electrode assembly 300 in which a separator 316 is interposed between a first electrode 317 and a second electrode 319, a current collector 500 for secondary batteries that is electrically connected to the electrode assembly 300, a casing 100 that accommodates the electrode assembly 300 therein, and a cap assembly 700 that seals the casing 100.

The electrode assembly 300 may be formed in such a way that the separator 316 is interposed between the first electrode 317 and the second electrode 319 that are alternately arranged. In other words, the electrode assembly 300 may be formed by arranging the separator 316 located between the first electrode 317 and the second electrode 319 and alternately stacking the first electrode 317, the separator 316, the second electrode 319, and the separator 316 in the listed order. The first electrode 317 and the second electrode 319 may be a positive electrode and a negative electrode, respectively, or, conversely, the first electrode 317 and the second electrode 319 may be a negative electrode and a positive electrode, respectively, as electrodes having opposite polarities.

Each of the first electrode 317 and the second electrode 319 may include an active electrode portion 312 or 314 that is a region where an active material is applied to a thin plate formed of a metal foil, and an electrode tab 311 or 315 that is a region where no active material is applied.

The first active electrode portion 312 may be formed by applying an active material such as a transition metal oxide to a metal foil such as aluminum. The second active electrode portion 314 may be formed by applying an active material such as graphite or carbon to a metal foil such as copper or nickel.

Each of the first electrode tab 311 and the second electrode tab 315 is formed by cutting or notching to protrude from the corresponding metal foil. Hence, the first electrode tab 311 and the second electrode tab 315 may be integrally formed with the metal foils of the first active electrode portion 312 and the second active electrode portion 314, respectively. In another example, the first and second electrode tabs 311, 315 may be integrally formed with the metal foils of the associated active electrode portion, but without cutting or notching a larger foil sheet. That is, the metal foils may be initially formed to have shapes that define electrode tabs integral therewith.

In other examples, the electrode tabs 311, 315 may not be integrally formed with the metal foils of the active electrode portions 312, 314, but instead separate electrode tabs 311, 315 may be joined to the metal foils, such as by welding. In any event, whether integrally formed or subsequently joined, the electrode tabs 311, 315 are understood to be electrically coupled to the metal foils of the respective electrodes 317, 319.

In other examples, the electrode tabs 311, 315 may not be integrally formed with the metal foils of the active electrode portions 312, 314, but instead separate electrode tabs 311, 315 may be joined to the metal foils, such as by welding. In any event, whether integrally formed or subsequently joined, the electrode tabs 311, 315 are understood to be electrically coupled to the metal foils of the respective electrodes 317, 319.

For simplicity, the electrode tabs may be referred to herein as being electrically coupled to the respective electrodes, but that does not imply the manner in which the electrode tabs are connected to the metal foils (whether integrally formed or subsequently joined), nor is it to be understood as implying that the electrode tabs cannot be considered to be part of the respective electrodes to which they are electrically coupled. That is, the electrode tabs may be said to be electrically coupled to the respective electrodes whether or not any electrode is considered to be a part of the electrode to which it is electrically coupled.

The first electrode tab 311 and the second electrode tab 315 may have different polarities, and may be spaced apart from each other by a distance in the longitudinal dimension (x-axis dimension).

A plurality of the thin films constituting a plurality of the first electrode tabs 311 may be grouped together into one or more groups, in each of which the electrode tabs 311 are connected to be in contact with each other, such as by ultrasonic welding, laser welding, or the like, in order to facilitate movement of current. Likewise, one or more groups of the second electrode tabs 315 may be formed by grouping together a plurality of the second electrode tabs and connecting them to be in contact with each other, such as by ultrasonic welding, laser welding, or the like, in order to facilitate movement of current. In some cases, any of the electrode tab groups may comprise a single electrode tab 311, 315.

The separator 316 is positioned between the first electrode 317 and the second electrode 319, and more specifically, between the first active electrode portion 312 and the second active electrode portion 314, thereby preventing a short circuit therebetween and allowing movement of ions. For example, the separator 316 may be formed of any of various materials such as polyethylene, polypropylene, or a composite film thereof.

In the present aspect, the electrode assembly 300 may be formed by winding the first electrode 317 and the second electrode 319 (wound type), or may be formed by laminating the first electrode 317 and the second electrode 319 parallel with each other (stacked type).

The current collector 500 for secondary batteries may include a first current collection component 510, a second current collection component 530, and an insulating connector 550. The insulating connector 550 may be in the form of an electrically insulating substrate connecting the first current collection component 510 to the second current collection component 530. Each of the first and second current collection components 510, 530 may be in the form of electrically conductive plate-shaped members. More specifically, the plate-shaped first and second current collection components 510, 530 may have a planar shape.

To couple the first and second current collection components 510, 530 to one another, the insulating connector 550 may receive each of the current collection components 510, 530 in a respective recessed region that is recessed into the thickness of the insulating connector 550. That is, in an arrangement where the longitudinal dimension (x-axis dimension) is horizontal or lateral, the insulating connector 550 may be elongated along that lateral dimension such that a longitudinal axis of the insulating connector extending between and connecting the first and second current collection components 510, 530 extends along the lateral dimension. Thus, the thickness of the insulating connector 550 may be in the height or vertical dimension (z-axis dimension), such that the recessed regions that receive the current collection components 510, 530 are recessed downwardly in the vertical dimension from an upper side of the insulating connector 550.

The first current collection component 510 may electrically connect a first terminal 710, which is exposed to the outside of the cap assembly 700, to at least one group of the first electrode tabs 311. The second current collection component 530 may electrically connect a second terminal 730, which is exposed to the outside of the cap assembly 700, to at least one group of the second electrode tabs 315.

One side of the first current collection component 510 may be connected to the one or more groups of first electrode tabs 311. Another side of the first current collection component 510 may be connected to the first terminal 710. Specifically, the first current collection component 510 may be indirectly connected to the first terminal 710 through a first connection terminal 511 or the like that extends upwardly away from the plate-shaped first current collection component 510.

One side of the second current collection component 530 may be connected to the one or more groups of second electrode tabs 315. Another side of the second current collection component 530 may be connected to the second terminal 730.

Similarly to the first current collection component 510, the second current collection component 530 may also be indirectly connected to the second terminal 730 through a second connection terminal 531 or the like that extends upwardly away from the plate-shaped second current collection component 530.

A detailed structure of the current collector 500 for secondary batteries and respective detailed coupling structures of one or more groups of the first electrode tabs 311 and the second electrode tabs 315 will be described below.

The cap assembly 700 may seal an opening of the casing 100 in which the electrode assembly 300 is accommodated, and may include a cap plate 750, the first terminal 710, and the second terminal 730.

The cap plate 750 may have a plate shape that covers the opening of the casing 100. The cap plate 750 may have a shape corresponding to that of the opening of the casing 100. The cap plate 750 may be formed of the same material as the casing 100, and may be fixed to the casing 100 by laser welding.

The cap plate 750 may be formed with an electrolyte injection hole 770 that is used for injection of electrolyte, a first terminal hole 711 into which the first connection terminal 511 is inserted, a second terminal hole 731 into which the second connection terminal 531 is inserted, and a vent hole 740 that opens when an internal pressure of the casing 100 exceeds a preset pressure value. However, the position of the vent hole 740 is not necessarily limited thereto, and the vent hole 740 may be positioned along any side of the casing 100, for example, in a side surface or a bottom surface of the casing 100.

The first terminal 710 and the second terminal 730 may be structured so as to protrude from the cap plate 750. The first terminal 710 may be electrically connected to the first electrode 317 through the first current collection component 510. The second terminal 730 may be electrically connected to the second electrode 319 through the second current collection component 530. Here, the first terminal 710 may be electrically connected to the first current collection component 510 through the first connection terminal 511. The second terminal 730 may also be electrically connected to the second current collection component 530 through the second connection terminal 531.

Each of the first terminal 710 and the second terminal 730 may be provided in the form of a generally plate-shaped structure having a circular shape or a rectangular shape. Each of the first terminal 710 and the second terminal 730 may be connected to a bus bar or the like.

A first insulator (not illustrated) may be disposed between the first terminal 710 and the cap plate 750 to insulate the first terminal 710 and the cap plate 750 from each other. In addition, a second insulator (not illustrated) may be disposed between the second terminal 730 and the cap plate 750 to insulate the second terminal 730 and the cap plate 750 from each other.

The first connection terminal 511 may have a post shape, and may be inserted into the first terminal hole 711 to electrically connect the first terminal 710 to the first current collection component 510. Similarly to the first connection terminal 511, the second connection terminal 531 may have a post shape, and may be inserted into the second terminal hole 731 to electrically connect the second terminal 730 to the second current collection component 530. Additional details regarding the structures of (and relating to) the first and second terminals, the first and second insulators, and the first and second connection terminals may be found in Korean Patent Application Nos. 10-2024-0110751 filed on Aug. 19, 2024, 10-2024-0123755 filed on Sep. 11, 2024, and 10-2025-0043060 filed on Apr. 2, 2025, the entire disclosures of which are incorporated herein by reference.

The casing 100 may form an external shape of the secondary battery 10, and may define therein a space to accommodate the electrode assembly 300 therein, with the opening located along one side of the casing 100. The casing 100 may have a rectangular parallelepiped shape, and may be formed of a rigid material capable of protecting the electrode assembly 300 accommodated therein. For example, the casing 100 may be formed of a metal such as aluminum or stainless steel.

Electrolyte may be received together with the electrode assembly 300 in the casing 100. The electrolyte may include a lithium salt such as LiPF₆ or LiBF₄ in an organic solvent such as ethylene carbonate (EC), propylene carbonate (PC), diethyl carbonate (DEC), ethyl methyl carbonate (EMC), or dimethyl carbonate (DMC). The electrolyte may be in a liquid, solid, or gel phase. At least in the case in which the electrolyte is a solid, the electrode assembly 300 may not include a separator 316, as the solid-state electrolyte may function as a separator.

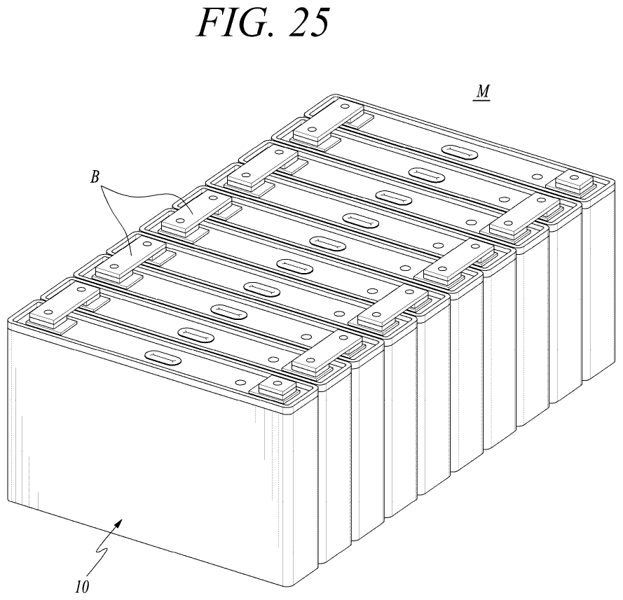

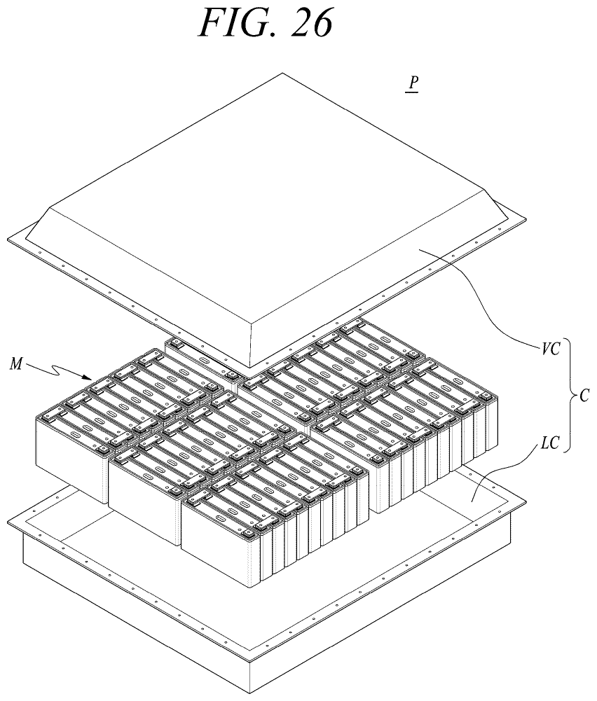

In an aspect, a battery module M may be configured to include a plurality of secondary batteries 10 according to the present aspect (see FIG. 25). The plurality of secondary batteries 10 may be connected to each other by a bus bar B or the like to constitute the battery module M. Furthermore, a battery pack P may be configured to include a plurality of battery modules M (see FIG. 26). The battery pack P may be configured by arranging the plurality of battery modules M in an upper pack housing VC and a lower pack housing LC that form a pack housing C. In addition, the battery pack P may be provided to a transportation unit that transports cargo, people, or performs tasks while moving. Such transportation units may include bicycles, heavy equipment, agricultural and fishery machinery, automobiles, buses, airplanes, and the like. Here, the automobiles may include an electric vehicle, a hybrid electric vehicle, or a plug-in hybrid electric vehicle. The automobiles may include four-wheeled or two-wheeled types. The transportation units may operate using power received from the battery pack P.

In an alternative arrangement (not illustrated), the battery pack P may not include battery modules M, and instead the secondary batteries 10 may be directly positioned in suitable arrangements within the battery pack P.

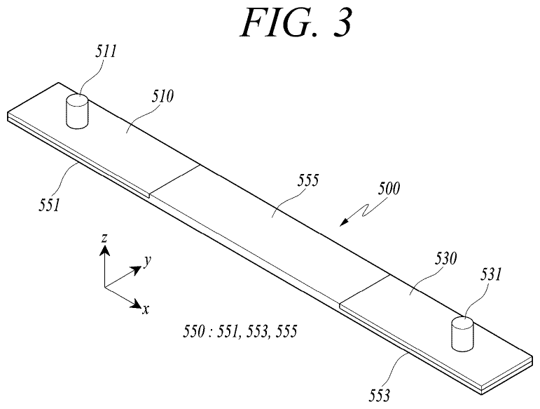

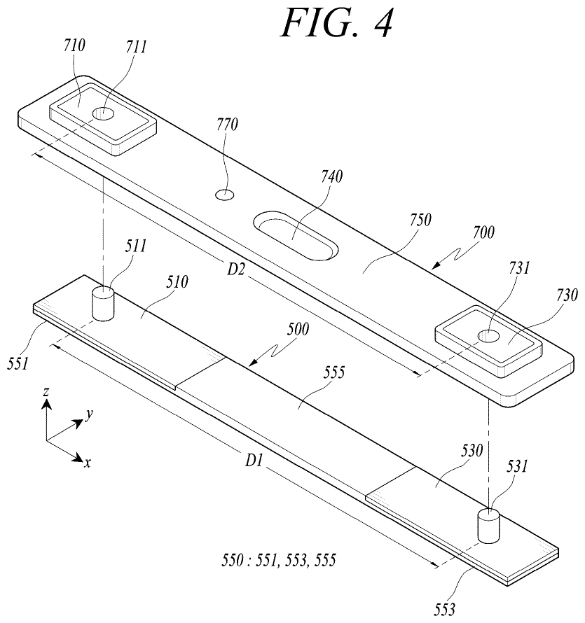

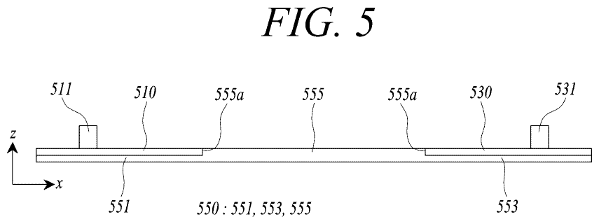

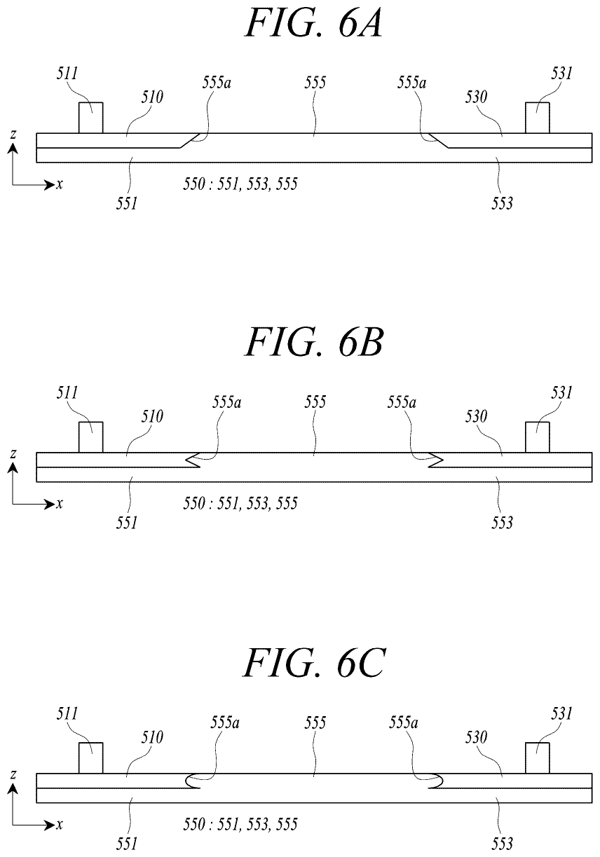

FIG. 3 is a perspective view of the current collector for secondary batteries. FIG. 4 is a perspective view illustrating the current collector for secondary batteries and the cap assembly together. FIG. 5 is a front elevation view illustrating the current collector for secondary batteries. FIGS. 6A-6C are front elevation views of modified examples of a current collector for secondary batteries, illustrating different intermediate connection portions.

Referring to FIGS. 3 and 4, the current collector 500 for secondary batteries includes the first current collection component 510, the second current collection component 530, and the insulating connector 550.

The insulating connector 550 is coupled to a side surface of the first current collection component 510 and a side surface of the second current collection component 530. Specifically, the insulating connector 550 may be positioned between respective side surfaces of the first current collection component 510 and the second current collection component 530 that face each other, and may be coupled to each of the facing side surfaces. The coupled insulating connector 550 connects the first current collection component 510 and the second current collection component 530, which are spaced apart from each other in the longitudinal dimension (x-axis dimension). The current collector 500 for secondary batteries, in which the first current collection component 510, the second current collection component 530, and the insulating connector 550 are connected to each other, may be coupled to the cap assembly 700 as an integrated component.

Each of the first current collection component 510 and the second current collection component 530 may have a substantially plate-shaped structure. Each of the first current collection component 510 and the second current collection component 530 may be made of a conductive metal.

The first connection terminal 511 and the second connection terminal 531 are respectively coupled to upper surfaces of the first current collection component 510 and the second current collection component 530. Each of the first connection terminal 511 and the second connection terminal 531 may have a post shape extending in a direction toward the cap assembly 700 (see FIG. 2). Each of the first connection terminal 511 and the second connection terminal 531 may be made of a metal material that is the same as that of the corresponding one of the first current collection component 510 and the second current collection component 530. The first connection terminal 511 and the second connection terminal 531 may be integrally formed with the first current collection component 510 and the second current collection component 530, respectively, or may be separately manufactured and joined by welding.

The insulating connector 550 of the current collector 500 may be configured such that the recessed regions that receive the current collection components 510, 530 are spaced apart from one another in the lateral dimension, which may be the longitudinal (or x-axis) dimension, as noted above. Thus, the first current collection component 510 and the second current collection component 530 are spaced apart from each other in the longitudinal dimension (x-axis dimension). The first current collection component 510 and second current collection component 530 that are spaced apart from each other are connected by the insulating connector 550.

The insulating connector 550 is coupled to the side edge surface 510a of the first current collection component 510 and the side edge surface 530a of the second current collection component 530. More specifically, in the arrangements illustrated in the figures, the thickness dimension of the plate-shaped first and second current collection components 510, 530 extends in the vertical (z-axis) dimension with the side edge surfaces of the first current collection component 510 and the second current collection component 530 facing each other. The insulating connector 550 may be connected to the first current collection component 510 and the second current collection component 530 so that the current collector 500 for secondary batteries may have an integrated structure.

An upper surface of the current collector 500 for secondary batteries, which includes the upper side of the insulating connector 550 and the upper sides of the first and second current collection components 510, 530, may have a flat shape. In other words, except for the connection terminals 511 and 531, the upper surfaces of the first current collection component 510, the second current collection component 530, and the insulating connector 550 may be contiguous with one another to define a flat shape without a stepped portion. That may be accomplished by the sizing of the current collection components, and the recessed regions that receive them, in the vertical dimension, such that upper sides of the first and second current collection components 510, 530 are flush with the upper side of the insulating connector 550, as shown in the figures. In alternative arrangements (not illustrated in the drawings), the upper sides of the first and second current collection components 510, 530 may be recessed further downwardly relative to the upper side of the insulating connector 550, or the upper sides of the first and second current collection components 510, 530 may project upwardly above the upper side of the insulating connector 550.

Due to the aforementioned structure, a vacant space between the current collector 500 for secondary batteries and the cap plate 750 may be reduced, thereby making it possible to enhance the energy density of the secondary battery 10.

In the present aspect, because the first current collection component 510 and the second current collection component 530 are connected to each other by the insulating connector 550, a distance D1 between the first connection terminal 511 and the second connection terminal 531 is constant. Here, the distance D1 between the first connection terminal 511 and the second connection terminal 531 may be equal to a distance D2 between the first terminal hole 711 and the second terminal hole 731.

In this case, even if only the first connection terminal 511 is aligned with the position of the first terminal hole 711, the second connection terminal 531 will also be aligned with the position of the second terminal hole 731. As a result, there is unlikely to be an occurrence of a deviation in the position of the second connection terminal 531, thereby improving the assemblability of the secondary battery 10.

Referring to FIG. 5, the insulating connector 550 may include an intermediate connection portion 555, a first wing portion 551, a second wing portion 553. The insulating connector 550 may have a shape in which the first wing portion 551 is formed on one side of the intermediate connection portion 555 and the second wing portion 553 is formed on a remaining side of the intermediate connection portion 555, with the intermediate connection portion 555 positioned therebetween.

The intermediate connection portion 555 may be located at the center of the insulating connector 550. The first current collection component 510 and the second current collection component 530 may be coupled to respective opposite side faces or side surfaces 555a of the intermediate connection portion 555 in the longitudinal dimension (x-axis dimension). In that arrangement, the side edge surfaces 510a, 530a of the first and second current collection components 510, 530 may abut the respective side faces 555a of the intermediate connection portion 555.

The intermediate connection portion 555 may be formed of an electrically insulating material. Accordingly, the intermediate connection portion 555 may insulate the first current collection component 510 and the second current collection component 530 from each other to prevent a short circuit, while still connecting the first current collection component 510 and the second current collection component 530.

The opposite side surfaces 555a of the intermediate connection portion 555 that abut the side edge surfaces 510a, 530a of the respective first and second current collection components 510, 530 may have various profiles in a cross-sectional plane extending in the x-z direction.

For example, as illustrated in FIG. 5, each of the opposite side surfaces 555a of the intermediate connection portion 555 may have a cross-section extend perpendicularly with respect to the upper surface of the intermediate connection portion 555.

Alternatively, as illustrated in FIG. 6A, each of the opposite side surfaces 555a of the intermediate connection portion 555 may be inclined obliquely with respect to the upper surface of the intermediate connection portion 555. In other alternatives, the side surfaces 555a of the intermediate connection portion 555 may abut the side edge surfaces 510a, 530a of the respective first and second current collection components 510 to define concave/convex mating interfaces. For example, those abutting surfaces may have wedge-shaped concave/convex profiles, as shown in FIG. 6B, or they may have or a curved profiles, as shown in FIG. 6C. Although the concave/convex mating interfaces in FIGS. 6B and 6C have their concavities facing inwardly towards the center of the insulating connector 550, other examples may have such shapes with concavities facing outwardly away from one another. Similarly, the in another example like that illustrated in FIG. 6A, the obliquely inclined planes of the mating interfaces may alternatively incline away from one another in the upwards direction. In such cases, because the areas of the opposite side surfaces 555a of the intermediate connection portion 555 to which the first current collection component 510 and the second current collection component 530 may be coupled increase, coupling strength may be improved.

The first wing portion 551 may be formed on the one side of the intermediate connection portion 555 in the longitudinal dimension (x-axis dimension). The first wing portion 551 may be located under the first current collection component 510, and may be placed parallel to the first current collection component 510 on the one side of the intermediate connection portion 555 in the longitudinal dimension (x-axis dimension). Here, the first wing portion 551 may be integrally formed with the intermediate connection portion 555, such that both portions are monolithically formed as a single piece of electrically insulating material.

A thickness (height in the z-axis dimension) of the first wing portion 551 may be smaller than a thickness (height in the z-axis dimension) of the intermediate connection portion 555. The first wing portion 551 and the intermediate connection portion 555 may be formed of the same material, and may have insulating properties. Accordingly, the first wing portion 551 may insulate the first electrode tabs 311 (see FIG. 2) and the first current collection component 510 from each other.

The second wing portion 553 may be formed on the remaining side of the intermediate connection portion 555 in the longitudinal dimension (x-axis dimension). The second wing portion 553 may be located under the second current collection component 530, and may be placed parallel to the second current collection component 530 on the remaining side of the intermediate connection portion 555 in the longitudinal dimension (x-axis dimension). Here, the second wing portion 553 may also be integrally formed with the intermediate connection portion 555, such that both portions are monolithically formed as a single piece of electrically insulating material.

A thickness (height in the z-axis dimension) of the second wing portion 553 may be smaller than that of the intermediate connection portion 555, and may be equal to the thickness (height in the z-axis dimension) of the first wing portion 551. The second wing portion 553 and the intermediate connection portion 555 may be formed of the same material, and may have insulating properties. Accordingly, the second wing portion 553 may insulate the second electrode tabs 315 (see FIG. 2) and the second current collection component 530 from each other.

The insulating connector 550 may be provided such that the intermediate connection portion 555, the first wing portion 551, and the second wing portion 553 are integrally formed, such that they are monolithically formed as a single piece of electrically insulating material. For example, the insulating connector 550 may be integrally formed through injection molding to include the intermediate connection portion 555, the first wing portion 551, and the second wing portion 553. In this regard, a method of manufacturing the current collector 500 for secondary batteries, including the insulating connector 550, will be described with reference to a separate aspect below.

A lower surface of the integrally formed insulating connector 550 may have a flat shape. In other words, lower surfaces of the intermediate connection portion 555, the first wing portion 551, and the second wing portion 553 may be formed flat without a stepped portion.

Because the intermediate connection portion 555 has a thickness (height in the z-axis dimension) greater than that of the first wing portion 551 and the second wing portion 553 disposed on the opposite side surfaces 555a, the insulating connector 550 may have a shape in which the intermediate connection portion 555 protrudes upward relative to the first wing portion 551 and the second wing portion 553. In other words, the insulating connector 550 may have a flat lower surface, and an upper surface having a shape in which the intermediate connection portion 555 protrudes upwardly.

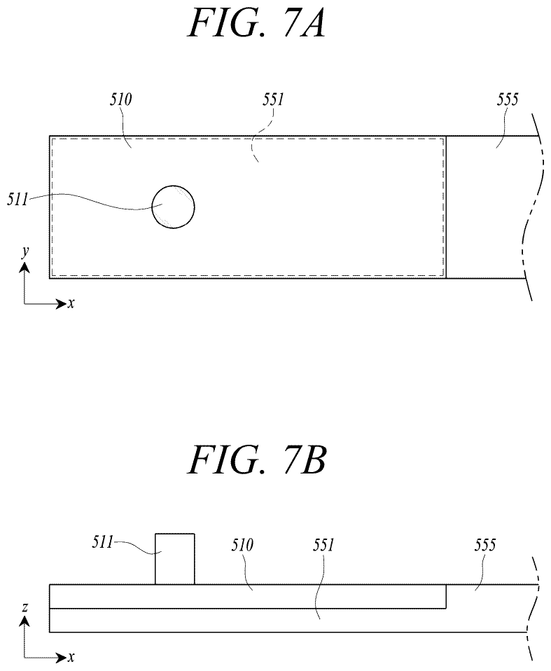

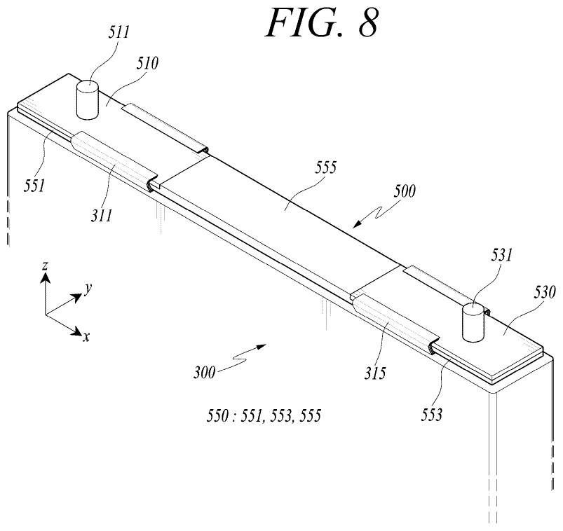

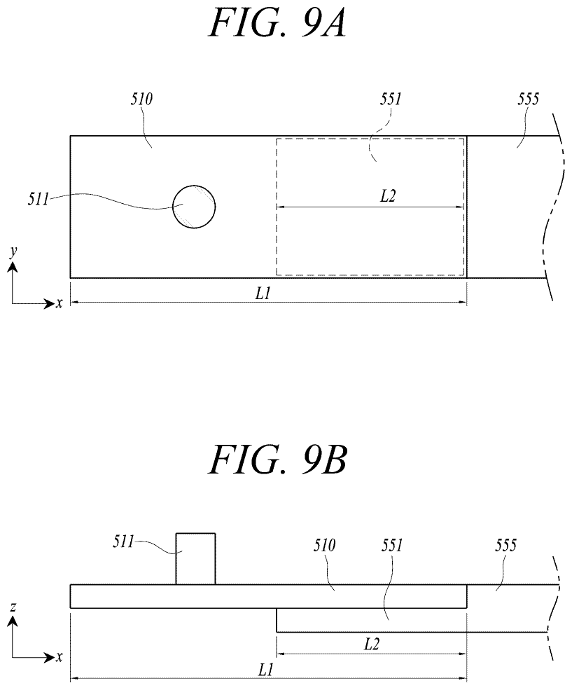

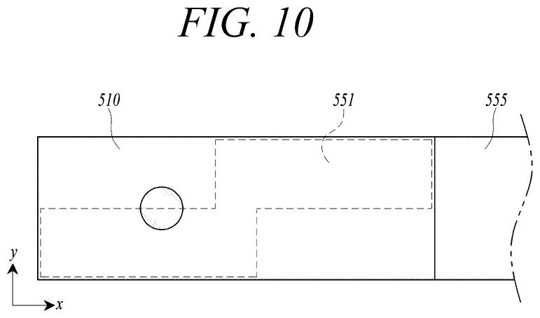

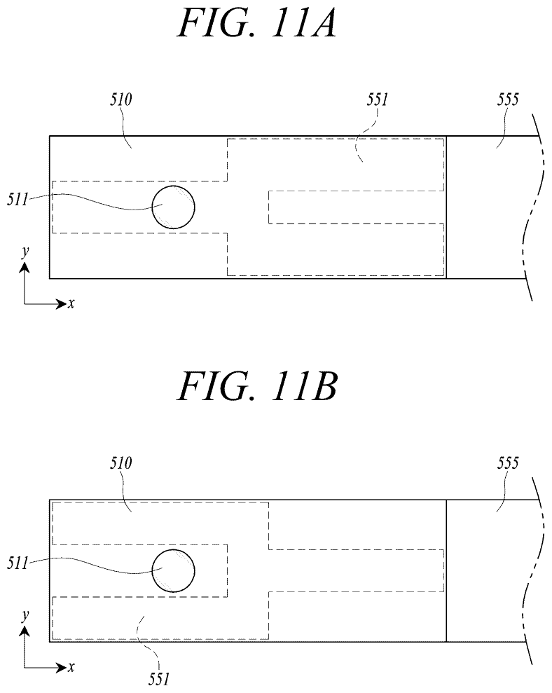

FIG. 7A is a schematic top plan view of a portion of a current collector for secondary batteries, illustrating the first current collection component and the first wing portion. FIG. 7B is a front elevation view of the portion of the current collector illustrated in FIG. 7A. FIG. 8 is a perspective view illustrating the electrode tabs coupled to the current collector for secondary batteries. FIGS. 9A to 9B are a schematic top plan view and front elevation view, respectively, of a portion of a current collector for secondary batteries, illustrating an alternative example of a first wing portion. FIG. 10 is a schematic top plan view of a portion of a current collector for secondary batteries, illustrating another alternative example of a first wing portion. FIGS. 11A to 11B are a schematic top plan view and front elevation view, respectively, of a portion of a current collector for secondary batteries, illustrating another alternative example of a first wing portion. For convenience of illustration, in FIGS. 7A, 9A, 10, and 11, the first current collection component 510 is illustrated with a solid line, and the first wing portion 551 is illustrated with a dotted line.

The structure of the first wing portion 551 and the coupling relationship with the first electrode tabs 311, which will be described below, may be equally applied to the second wing portion 553 and the second electrode tabs 315. Therefore, redundant descriptions of the second wing portion 553 and the second electrode tabs 315 will be omitted.

Referring to FIGS. 7A and 7B, a shape of the first wing portion 551 may correspond to that of the first current collection component 510. In other words, the first wing portion 551 located under the first current collection component 510 may be formed to have the same shape and the same size as the first current collection component 510.

For example, in the case where the first current collection component 510 has a rectangular shape, the first wing portion 551 located under the first current collection component 510 may also have a rectangular shape with the same area as the first current collection component 510.

If the size of the first wing portion 551 is greater than that of the first current collection component 510, a problem could arise in that it may be difficult for the current collector 500 to be accommodated in the casing 100 (see FIG. 2). Furthermore, if the size of the first wing portion 551 is smaller than that of the first current collection component 510, there could be a problem in that the first electrode tabs 311 (see FIG. 8) and the first current collection component 510 may not be reliably insulated from each other.

If the first wing portion 551 has the same shape and the same size as the first current collection component 510, not only can the current collector 500 be accommodated in the casing 100 (see FIG. 2), but also the first wing portion 551 can reliably insulate the first electrode tabs 311 (see FIG. 8) from the first current collection component 510.

Because a lower portion of the first current collection component 510 is covered by the first wing portion 551, the first electrode tabs 311 may be coupled to the upper surface of the first current collection component 510 in the manner illustrated in FIG. 8.

Referring to FIG. 8, the groups of first electrode tabs 311 may bypass the first wing portion 551 in the width dimension (y-axis dimension) and be coupled to the upper surface of the first current collection component 510. The group(s) of first electrode tabs 311 may be coupled to the first current collection component 510 by welding. For example, laser welding, ultrasonic welding, or the like may be used for the welding. As shown in FIG. 8, the first electrode tabs 311 may be joined together into two groups that are coupled to opposite sides of the first current collection component 510 in the width (y-axis) dimension. However, in other examples, more or fewer groups of first electrode tabs 311 may be coupled to the first current collection component 510. Furthermore, the groups of first electrode tabs 311 may be coupled to the first current collection component 510 in a region that is spaced from the first connection terminal 511 in the longitudinal (x-axis) dimension, as shown in FIG. 8. The region in which the electrode tabs are coupled to the current collection component may be referred to as a “coupling region.”

Unlike the foregoing, the first wing portion 551 may be formed in various shapes. Specifically, the first wing portion 551 may be formed to cover only a portion of the lower surface of the first current collection component 510.

For instance, referring to FIGS. 9A and 9B, a width of the first wing portion 551 may be the same as that of the first current collection component 510, but a length L2 of the first wing portion 551 may be less than a length L1 of the first current collection component 510. Accordingly, the lower surface of the first current collection component 510 may be divided into a region covered by the first wing portion 551 and a region not covered by the first wing portion 551.

The region of the lower surface of the first current collection component 510 that is not covered by the first wing portion 551 (also referred to as an open region) may expose a corresponding portion of an underside of the first current collection component 510 that faces the electrode assembly 300 (see FIG. 8) in a vertical dimension. In this case, the first electrode tabs 311 (see FIG. 8) may be coupled to the lower surface of the first current collection component 510 via that open region.

In the region of the lower surface of the first current collection component 510 that is covered by the first wing portion 551, the first electrode tabs 311 (see FIG. 8) may bypass the first wing portion 551 and be coupled to the upper surface of the first current collection component 510.

In another example, as illustrated in FIG. 10, the first wing portion 551 may cover the lower surface of the first current collection component 510 in a Z-shaped pattern.

Alternatively, as illustrated in FIGS. 11A-B, the first wing portion 551 may cover a central region of the lower surface of the first current collection component 510 in the width (y-axis) dimension along one portion of the first current collection component 510 in the longitudinal dimension (x-axis dimension), and the first wing portion 551 may cover opposing side portions in the width dimension along another portion of the first current collection component 510 in the longitudinal dimension. As shown in FIGS. 11A-B, the two portions of the first current collection component 510 in the longitudinal dimension may be each represent half of the first current collection component 510 in the longitudinal dimension.

In this case as well, partial regions of the lower surface of the first current collection component 510 that are not covered by the first wing portion 551 (i.e., open regions) allow the first electrode tabs 311 (see FIG. 8) to be coupled to the lower surface of the first current collection component 510. In a remaining region(s) of the lower surface of the first current collection component 510 that are covered by the first wing portion 551, the first electrode tabs 311 (see FIG. 8) may be coupled to the upper surface of the first current collection component 510.

Hereinafter, a secondary battery according to a second aspect of the present disclosure will be described.

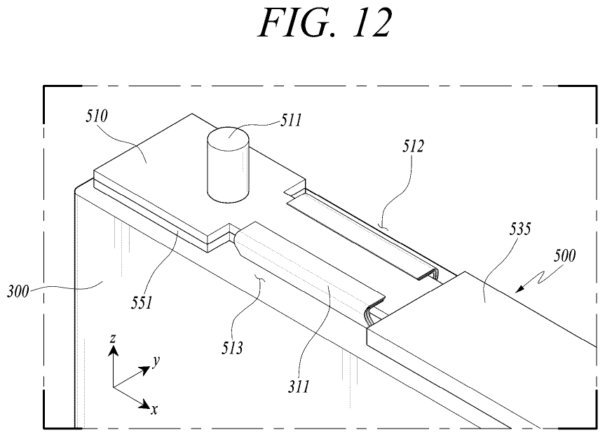

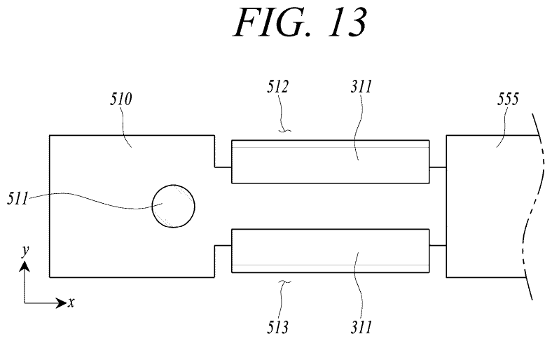

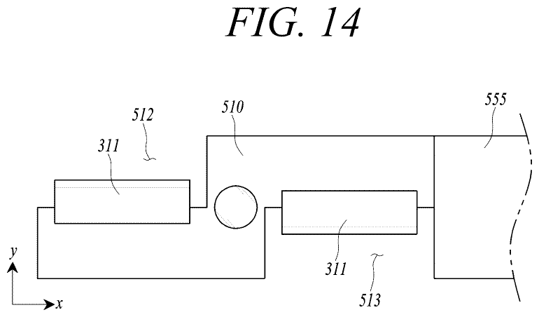

FIG. 12 is an enlarged perspective view of a portion of a current collector of a secondary battery according to a second aspect of the present disclosure. FIG. 13 is a top plan view of the portion of the current collector of FIG. 12. FIG. 14 is a top plan view of a portion of a current collector of a secondary battery illustrating a modified example of a first current collection component of FIG. 13.

A secondary battery according to the second aspect of the present disclosure has the same structure as the secondary battery according to the first aspect described above, except for a first current collection component 510 and a first wing portion 551. Therefore, a redundant description of the same configuration will be omitted. Furthermore, the structures of a second current collection component 530 and a second wing portion 553 are the same as those of the first current collection component 510 and the first wing portion 551; therefore, descriptions of the structures of the second current collection component 530 and the second wing portion 553 are to be understood as being the same as those of the first current collection component 510 and the first wing portion 551.

Referring to FIGS. 12 and 13, the first current collection component 510 may include a first cutout 512 located along one side in the width dimension (y-axis dimension), and a second cutout 513 located along the opposing side in the width dimension.

The first cutout 512 and the second cutout 513 may each have a rectangular shape, and may be located along the first current collection component 510 such that they have the same positions as one another along the longitudinal dimension (x-axis dimension) of the first current collection component 510.

A shape of the first wing portion 551 may correspond to that of the first current collection component 510. In other words, the shape and size of the first wing portion 551 may be the same as those of the first current collection component 510 in which the cutouts 512 and 513 are formed.

As illustrated in FIG. 14, in a different example, the first cutout 512 and the second cutout 513 may be located along the first current collection component 510 such that they do not have the same positions as one another along the longitudinal dimension (x-axis dimension) of the first current collection component 510. In other words, the first cutout 512 and the second cutout 513 may have positions along the first current collection component 510 that are offset from one another along the longitudinal dimension. In some examples, the first and second cutouts 512, 513 may partially overlap one another along the longitudinal dimension, and in other examples the first and second cutouts 512, 513 may be spaced apart from one another along the longitudinal dimension, as shown in FIG. 14.

According to the present disclosure, first electrode tabs 311 disposed under the first cutout 512 and the second cutout 513 may be exposed without being blocked at an upper side thereof by the first wing portion 551 or the first current collection component 510. Accordingly, the first electrode tabs 311 may be coupled to the upper surface of the first current collection component 510 by bypassing the first wing portion 551 without being excessively bent. Therefore, the electrical stability of the secondary battery 10 can be improved. Moreover, as shown in FIG. 12 and FIG. 14, as in the example of FIG. 8, the groups of first electrode tabs 311 may be coupled to the first current collection component 510 in a region (or regions) spaced from the first current connection terminal 511 in the longitudinal (x-axis) dimension.

Hereinafter, a secondary battery according to a third aspect of the present disclosure will be described.

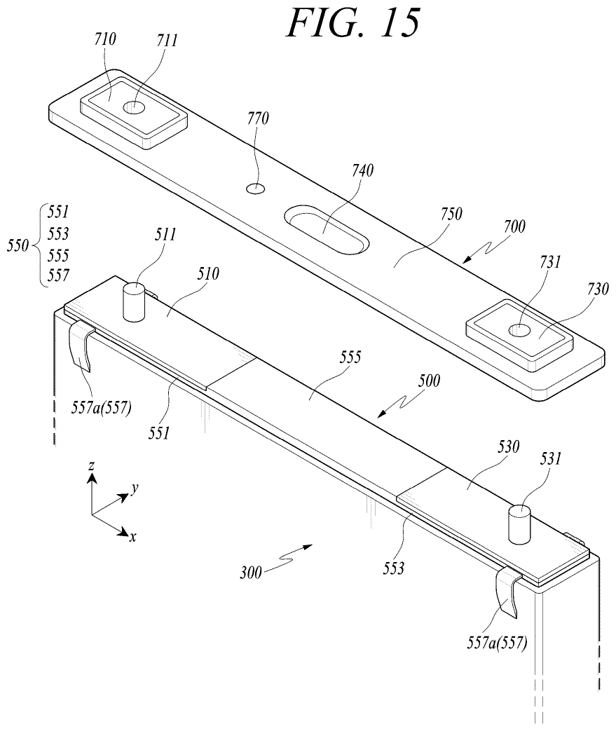

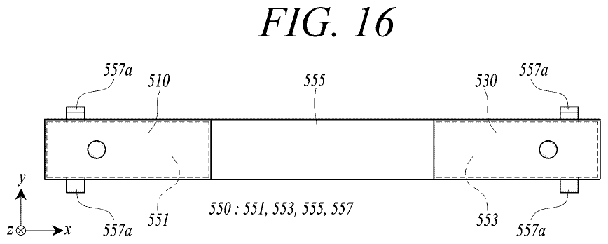

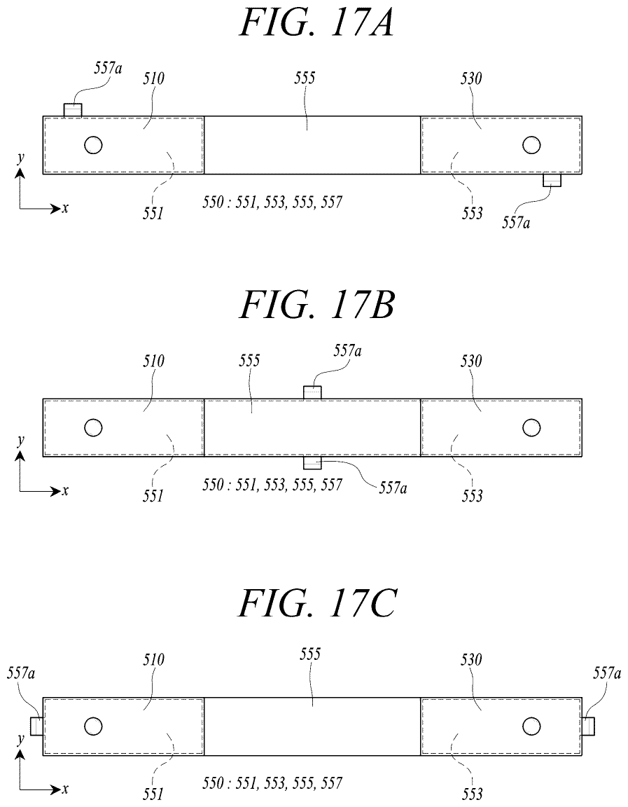

FIG. 15 is a perspective view illustrating a current collector for secondary batteries and a cap assembly according to the third aspect of the present disclosure. FIG. 16 is a schematic top plan view illustrating the current collector for secondary batteries of FIG. 15. FIGS. 17A-17C are schematic top plan views of modified examples of a current collector for secondary batteries, illustrating different fastening rods.

The secondary battery according to the third aspect of the present disclosure has the same structure as the secondary battery according to the first aspect described above, except for a securement extension 557a; therefore, a redundant description of the same configuration will be omitted.

Referring to FIGS. 15 and 16, the current collector 500 for secondary batteries may further include a fastening portion or securement extension 557 that fastens the insulating connector 550 to an upper surface of the electrode assembly 300.

The insulating connector 550 may be supported on a portion of the electrode assembly 300 by the securement extension 557 and thereby fastened to the upper surface of the electrode assembly 300. Specifically, the securement extension 557 may include a plurality of fastening rods 557a that extend downwardly from opposing sides of the insulating connector 550 in the width (y-axis) dimension so as to securely engage opposing side surfaces of the electrode assembly 300 therebetween. For example, the fastening rods 557a may grip opposite side surfaces in the width dimension.

The fastening rods 557a may be formed of an insulating material. A pair of fastening rods 557a may be formed along opposite side surfaces of the first wing portion 551 in the width dimension (y-axis dimension), and another pair of fastening rods 557a may be formed at opposite side surfaces of the second wing portion 553 in the width dimension (y-axis dimension).

Taking the first wing portion 551 as a representative example, a pair of fastening rods 557a may protrude outward from the first wing portion 551 in the width dimension (y-axis dimension), and free ends of the fastening rods 557a extending downwardly in the z-axis dimension may be bent back towards the electrode assembly 300 in the width dimension.

The pair of fastening rods 557a may be secured with respect to the electrode assembly by pressing the bent free ends thereof against opposite side surfaces of the electrode assembly 300 in the width dimension (y-axis dimension). In that regard, the pair of fastening rods 557a may be somewhat flexible and biased inwardly towards one another in the width dimension.

The insulating connector 550 may be supported by the plurality of fastening rods 557a and thereby fastened to the upper surface of the electrode assembly 300.

Referring to FIGS. 17A-C, the pair of fastening rods 557a may be formed at various positions. For example, as shown in FIG. 17A, the pair of fastening rods 557a may be formed on a +y-axis dimension side surface of the first wing portion 551 and on a −y-axis dimension side surface of the second wing portion 553. Alternatively, as shown in FIG. 17B, the pair of fastening rods 557a may be formed on opposite side surfaces of the intermediate connection portion 555 in the width dimension (y-axis dimension). As shown in FIG. 17C, the pair of fastening rods 557a may be formed on a −x-axis dimension side surface of the first wing portion 551 and on a +x-axis dimension side surface of the second wing portion 553.

According to the present aspect, the insulating connector 550 may be fastened to the upper surface of the electrode assembly 300 by the fastening rods 557a. Therefore, wobbling can be prevented when the connection terminals 511 and 531 (see FIG. 15) are inserted into the terminal holes 711 and 731 (see FIG. 15). As a result, the assemblability of the secondary battery 10 may be improved.

Hereinafter, a secondary battery according to a fourth aspect of the present disclosure will be described.

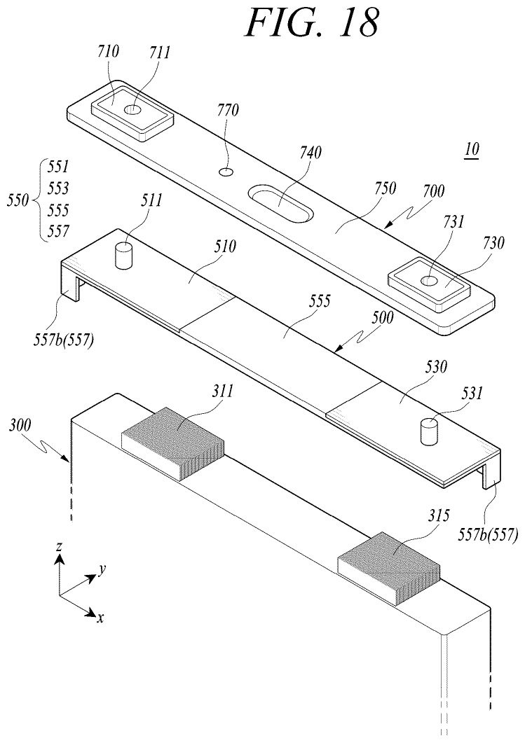

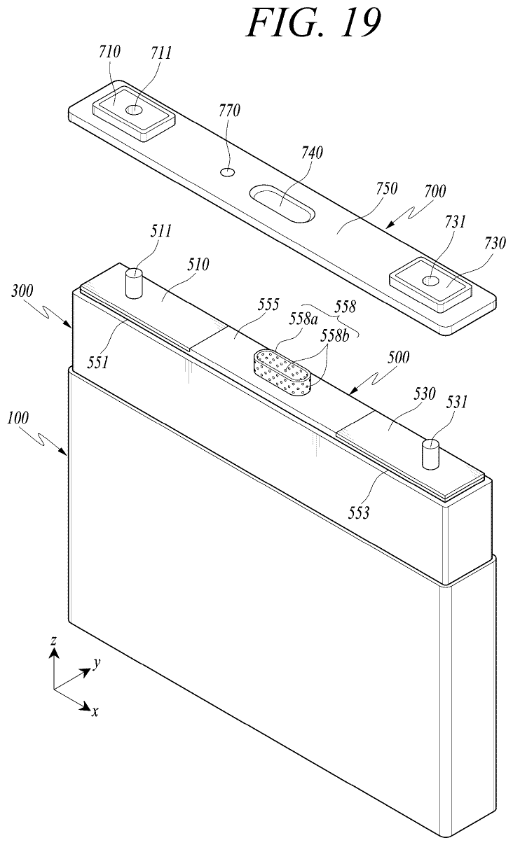

FIG. 18 is a perspective view illustrating a current collector of the secondary battery according to the fourth aspect of the present disclosure. The secondary battery according to the fourth aspect of the present disclosure has the same structure as the secondary battery according to the first aspect, except for a corner guard 557b; therefore, a redundant description of the same configuration will be omitted.

Referring to FIG. 18, the fastening portion or securement extension 557 may include a plurality of corner guards 557b that press corners of the electrode assembly 300.

The plurality of corner guards 557b may be formed of an insulating material. The plurality of the corner guards 557b may be formed in pairs at a corner of the first wing portion 551 and a corner of the second wing portion 553. The pair of the corner guards 557b may be positioned at opposing corners in a diagonal direction.

The pair of corner guards 557b may have a shape extending downwardly from the insulating connector 550 from the corner of the first wing portion 551 and the corner of the second wing portion 553. The pair of corner guards 557b may enclose diagonally opposing corners of the electrode assembly 300 by extending along portions of adjoining sides of the electrode assembly 300 that meet to define the respective corners.

The pair of corner guards 557b may guide the insulating connector 550 along the diagonally opposing corners of the electrode assembly 300 when the insulating connector 550 is positioned on the electrode assembly 300. The corner guards 557b may securely engage (e.g., by pressing) the diagonally opposing corners of the electrode assembly 300 so as to fasten the insulating connector 550 along the upper side of the electrode assembly 300.

According to the present disclosure, the insulating connector 550 may be secured to the upper side of the electrode assembly 300 by the corner guards 557b so as to prevent wobbling when the connection terminals 511 and 531 (see FIG. 15) are inserted into the terminal holes 711 and 731 (see FIG. 15). As a result, the assemblability of the secondary battery 100 can be improved.

Hereinafter, a secondary battery according to a fifth aspect of the present disclosure will be described.

FIG. 19 is a perspective view of a partially exploded configuration of a secondary battery, illustrating a current collector and a cap assembly according to the fifth aspect of the present disclosure. The secondary battery according to the fifth aspect of the present disclosure has the same structure as the secondary battery according to the first aspect, except for a leakage blocking portion 558; therefore, a redundant description of the same configuration will be omitted.

Referring to FIG. 19, the leakage blocking portion 558 may be coupled to the upper surface of the intermediate connection portion 555.

The leakage blocking portion 558 may protrude upward from the upper surface of the intermediate connection portion 555 toward the vent hole 740. In other words, the vent hole 740 may be positioned above (in the +z-axis dimension of) the leakage blocking portion 558. Facing the vent hole 740, an upper portion of the leakage blocking portion 558 may be open. A lower portion of the leakage blocking portion 558 may be blocked by the intermediate connection portion 555, or alternatively, may be open toward the electrode assembly 300 by penetrating through the intermediate connection portion 555.

The leakage blocking portion 558 may be sectioned into a sidewall 558a defining an internal space therein. In a top plan view (in the +z-axis dimension) of the leakage blocking portion 558, a shape defined by the sidewall 558a may correspond to the shape of the vent hole 740. The sidewall 558a may have the same shape and the same size as the vent hole 740. For example, a shape defined by an inner periphery of the sidewall 558a may match the shape of the vent hole 740.

Accordingly, the sidewall 558a may be supported between the intermediate connection portion 555 and the cap plate 750, and the open upper portion of the leakage blocking portion 558 may be arranged to face the vent hole 740. In this case, a height of the sidewall 558a may be smaller than that of the connection terminals 511 and 531.

A plurality of pores 558b may be formed in the sidewall 558a. Thus, in the case where the internal pressure of the casing 100 exceeds a preset pressure value and the vent hole 740 thus opens, air inside the casing 100 may pass through the pores 558b, but the electrolyte inside the casing 100 may be blocked by the sidewall 558a. In other words, the leakage blocking portion 558 may block the electrolyte while selectively allowing only air to flow into the internal space through the plurality of pores 558b. The air introduced into the internal space may be discharged to the outside through the vent hole 740.

In the present aspect, the leakage blocking portion 558 can prevent the electrolyte inside the casing 100 from leaking to the outside of the vent hole 740, while allowing only air inside the casing 100 to be discharged to the outside through the vent hole 740. Accordingly, it is possible to solve the problem in which not only air but also the electrolyte is discharged to the outside when the vent hole 740 opens.

Hereinafter, a secondary battery according to a sixth aspect of the present disclosure will be described.

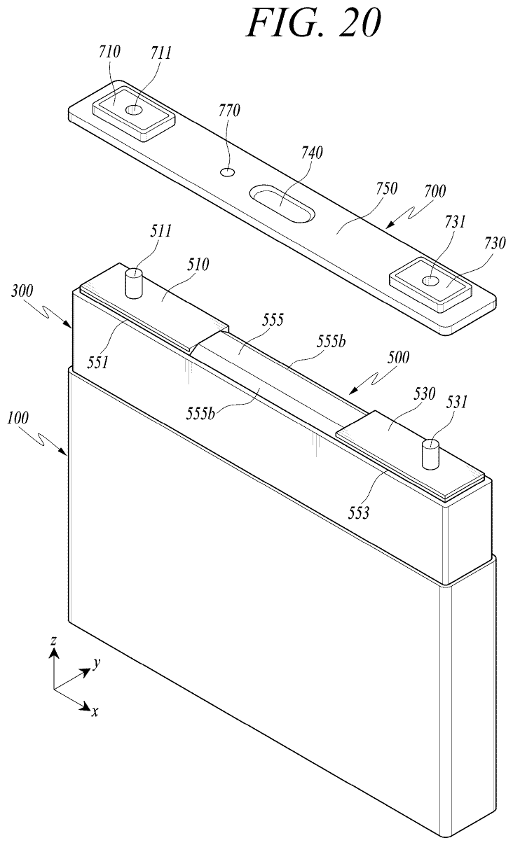

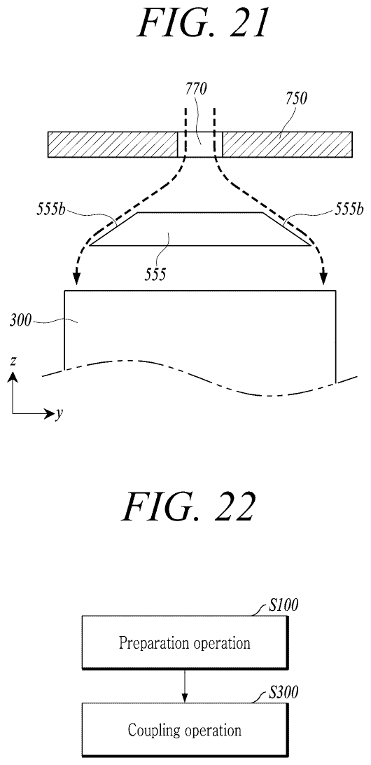

FIG. 20 is a perspective view of a partially exploded configuration of a secondary battery, illustrating a current collector and a cap assembly according to the sixth aspect of the present disclosure. FIG. 21 is a schematic cross-sectional side view of a portion of the current collector and cap assembly of FIG. 20.

The secondary battery according to the sixth aspect of the present disclosure has the same structure as the secondary battery according to the first aspect, except for differences with respect to the intermediate connection portion 555; therefore, a redundant description of the same configuration will be omitted.

Referring to FIGS. 20 and 21, side edges 555b of the intermediate connection portion 555 that oppose one another in the width (y-axis) dimension and extend along the longitudinal (x-axis) dimension may each define a plane inclined obliquely relative to the vertical (z-axis) dimension. Specifically, the width-dimension side edges 555b of the intermediate connection portion 555 may be inclined such that they slope downwardly as they extend outwardly away from the center of the intermediate connection portion 555 in the width dimension. The width-dimension side edges 555b may be inclined at an angle ranging from approximately 30° to approximately 70°, and preferably from 40° to 60°, with respect to a bottom surface of the intermediate connection portion 555. A width (y-axis dimension length) of the intermediate connection portion 555 may increase from an upper portion thereof toward a lower portion thereof, as shown in FIGS. 20-21.

The electrolyte injection hole 770 may be positioned over the intermediate connection portion 555. Thus, electrolyte injected through the electrolyte injection hole 770 may be guided along the width-dimension side edges 555b of the intermediate connection portion 555, such that it may be better injected into the electrode assembly 300.

According to the present aspect, the electrolyte injected through the electrolyte injection hole 770 may be reliably injected into the electrode assembly 300 along the width-dimension side surfaces 555b of the intermediate connection portion 555, without flowing toward the current collection components 510 and 530 or the connection terminals 511 and 531.

Hereinafter, a method of manufacturing a current collector for secondary batteries that is provided in a secondary battery according to a seventh aspect of the present disclosure will be described.

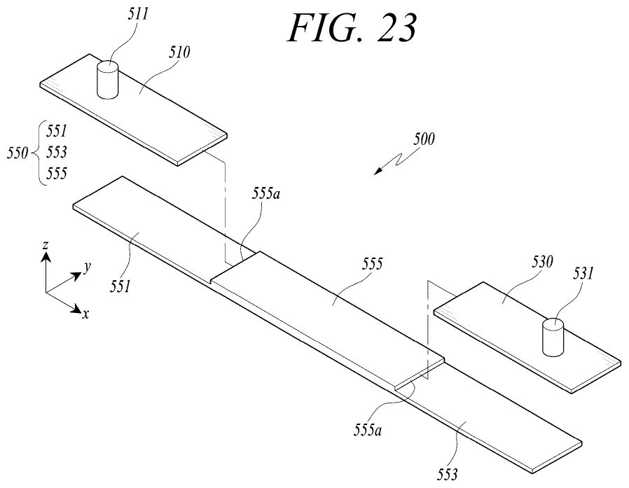

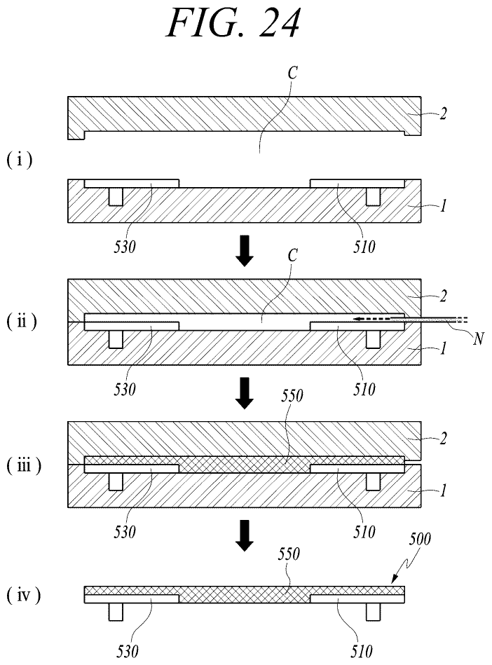

FIG. 22 is a flowchart of the method of manufacturing the current collector provided in the secondary battery according to the seventh aspect of the present disclosure. FIG. 23 is a perspective schematic view of a current collector of a secondary battery, illustrating a coupling operation. FIG. 24 includes schematic side cross-sectional views of steps of a coupling operation.

Except for the method of manufacturing the current collector 500 for secondary batteries, the secondary battery according to the seventh aspect of the present disclosure has the same structure as the secondary battery according to the first aspect described above; therefore, a redundant description of the same configuration will be omitted.

Referring to FIGS. 22 and 23, the method of manufacturing the collector for secondary batteries may include a preparation operation S100 of preparing the first current collection component 510 and the second current collection component 530, and a coupling operation S300 of coupling the first current collection component 510 and the second current collection component 530 by the insulating connector 550.

In the preparation operation (S100), the first current collection component 510 and the second current collection component 530 may be fabricated. The first current collection component 510 and the second current collection component 530 may be individually fabricated. The first current collection component 510 and the second current collection component 530 that are fabricated may be provided with the first connection terminal 511 and the second connection terminal 531, respectively.

In the coupling operation S300, the first current collection component 510 and the second current collection component 530 that are fabricated may be coupled to each other via the insulating connector 550. The first current collection component 510 and the second current collection component 530 may be secured to the insulating connector 550, such as by being secured to the side surfaces of the insulating connector 550. More specifically, side edge surfaces 510a, 530a of the first and second current collection components 510, 530 may be secured to the respective opposite side surfaces 555a of the intermediate connection portion 555, thus connecting the first and second current collection components 510, 530 to each other.

The current collection components 510 and 530 may be coupled or secured to the insulating connector 550, and more specifically, the side edge surfaces 510a, 530a of the first and second current collection components 510, 530 may be secured to the opposite side surfaces 555a of the intermediate connection portion 555, by an adhesive. The adhesive may refer to any means for attaching the current collection components 510 and 530 to the solidified insulating connector 550. For example, the adhesive may be an adhesive film or an adhesive liquid.

Alternatively, in the coupling operation S300, the insulating connector 550 may be coupled or secured to the first current collection component 510 and the second current collection component 530 by injection molding.

FIG. 24 is a flowchart for describing a modified example of the coupling operation of FIG. 22, and illustrates an injection molding process of the current collector 500 for secondary batteries.

Referring to FIG. 24, the current collector 500 for secondary batteries may be manufactured by injection molding. Specifically, the first current collection component 510 and the second current collection component 530 may be inserted into a cavity C inside molds 1 and 2, and the insulating connector 550 may be formed by injection molding. During the injection molding process of the insulating connector 550, the inserted first current collection component 510 and the inserted second current collection component 530 may be coupled to the insulating connector 550.

More specifically, the current collector 500 for secondary batteries may be manufactured through (i) a process of opening the molds 1 and 2 and inserting the first current collection component 510 and the second current collection component 530 into the cavity C, (ii) a process of closing the molds 1 and 2 and injecting a molten material into the cavity C through a nozzle N, (iii) a process of forming the insulating connector 550 by cooling the molten material disposed within the cavity C, and (iv) a process of separating the formed insulating connector 550 from the molds 1 and 2.

In other words, the current collector 500 for secondary batteries may be manufactured by insert injection molding. The first current collection component 510 and the second current collection component 530 may thus be coupled during the injection molding process of the insulating connector 550.

According to the present aspect, the first current collection component 510 and the second current collection component 530 may be separately coupled to the insulating connector 550, or they may be coupled thereto through the injection molding process of forming the insulating connector 550. In the case of the injection molding process, since a separate process for coupling the current collection components 510 and 530 to the insulating connector 550 is not required, the productivity of the current collector 500 for secondary batteries may be improved.

As described above, according to an aspect of the present disclosure, a current collection component has an integrated structure, thereby improving assemblability with a cap assembly.

While the present disclosure has been described with respect to the specific aspects, it will be apparent to those skilled in the art that various changes or modifications of the present disclosure are possible by adding, changing, or deleting components without departing from the spirit of the present disclosure as defined in the following claims. It should be noted that these changes or modifications also fall within the scope of the present disclosure.

What is claimed is:

1. A current collector for secondary batteries, comprising:
an electrically insulating substrate having a first recessed region recessed downwardly in a vertical dimension from an upper side of the substrate so as to define a first side face of the first recessed region, the substrate having a second recessed region recessed downwardly in the vertical dimension from the upper side of the substrate so as to define a second side face of the second recessed region, the first and second recessed regions being spaced apart from one another in a lateral dimension of the substrate;
an electrically conductive first current collecting plate member at least partially received in the first recessed region of the substrate so that a side edge surface of the first current collecting plate member in a thickness dimension thereof abuts the first side face of the first recessed region, the first current collecting plate member being coupled to a first connection terminal extending away from the first current collecting plate member; and
an electrically conductive second current collecting plate member at least partially received in the second recessed region of the substrate so that a side edge surface of the second current collecting plate member in a thickness dimension thereof abuts the second side face of the second recessed region, the second current colleting plate member being coupled to a second connection terminal extending away from the second current collecting plate member.

2. The current collector of claim 1, wherein the first and second current collecting plate members each have a planar shape.

3. The current collector of claim 1, wherein the substrate includes an intermediate portion extending between the first and second side faces, the upper side of the substrate in the intermediate portion being flush with an upper side of each of the first and second current collecting plate members.

4. The current collector of claim 1, wherein the substrate includes a first portion extending underneath the first current collecting plate member, a second portion extending underneath the second current collecting plate member, and an intermediate portion extending between the first and second side faces of the respective first and second recessed regions, wherein the intermediate portion, the first portion, and the second portion are all monolithically formed as a single piece of electrically insulating material.

5. The current collector of claim 1, wherein the substrate is elongated along the lateral dimension such that the substrate extends along a longitudinal axis extending between and connecting the first and second current collecting plate members.

6. The current collector of claim 1, wherein the side edge surface of the first current collecting plate member abuts the first side face of the first recessed region to define a first plane inclined obliquely relative to the vertical dimension, and wherein the side edge surface of the second current collecting plate member abuts the second side face of the second recessed region to define a second plane inclined obliquely relative to the vertical dimension.

7. The current collector of claim 1, wherein the side edge surface of the first current collecting plate member and the first side face of the first recessed region abut to define a first concave/convex mating interface therebetween, and wherein the side edge surface of the second current collecting plate member and the second side face of the second recessed region abut to define a second concave/convex mating interface therebetween.

8. The current collector of claim 1, wherein the substrate includes a first open region where the substrate does not extend below the first current collecting plate member so as to expose a corresponding portion of an underside of the first current collecting plate member, and wherein the substrate includes a second open region where the substrate does not extend below the second current collecting plate member so as to expose a corresponding portion of an underside of the second current collecting plate member.

9. The current collector of claim 1, wherein the first current collecting plate member has opposing first and second sides extending along the lateral dimension, a first cutout being defined along the first side and extending into the first current collecting plate towards the second side, and a second cutout being defined along the second side and extending into the first current collecting plate towards the first side.

10. The current collector of claim 9, wherein the first cutout and the second cutout are offset from one another along the lateral dimension.

11. The current collector of claim 1, wherein the substrate includes first and second securement extensions extending downwardly from opposing sides of the substrate so as to securely engage opposing side surfaces of an electrode assembly therebetween.

12. The current collector of claim 11, wherein the first and second securement extensions are positioned at diagonally opposing corners of the substrate, each of the first and second securement extensions being configured to securely engage both a respective one of the opposing side surfaces of the electrode assembly and a respective adjoining side surface at a respective corner of the electrode assembly.

13. The current collector of claim 1, wherein the substrate includes an intermediate portion extending between the first and second side faces, the upper side of the substrate in the intermediate portion having opposing first and second edges extending along the lateral dimension, wherein the first and second edges each define a respective plane inclined obliquely relative to the vertical dimension.

14. The current collector of claim 1, wherein the first connection terminal extends upwardly along the vertical dimension from an upper side of the first current collecting plate member, and wherein the second connection terminal extends upwardly along the vertical dimension from an upper side of the second current collecting plate member.

15. A secondary battery, comprising:
a casing:
an electrode assembly positioned within the casing, the electrode assembly including a plurality of tabs electrically coupled to respective electrodes of the electrode assembly, the plurality of tabs extending upwardly from the electrode assembly;
a cap assembly positioned above the electrode assembly and enclosing the casing, the cap assembly including a first terminal and a second terminal; and
the current collector of claim 14 positioned within the casing above the electrode assembly and below the cap assembly,
wherein a first group of the plurality of tabs having a first polarity are electrically coupled to the first current collecting plate member of the current collector, a second group of the plurality of tabs having a second polarity are electrically coupled to the second current collecting plate member of the current collector, the first connection terminal is electrically coupled to the first terminal of the cap assembly, and the second connection terminal is electrically coupled to the second terminal of the cap assembly.

16. The secondary battery of claim 15, wherein the cap assembly includes a cap plate having a first terminal hole and a second terminal hole, wherein the first connection terminal extends within the first terminal hole so as to electrically couple with the first terminal, and the second connection terminal extends within the second terminal hole so as to electrically couple with the second terminal.

17. The secondary battery of claim 15, wherein the first group of the plurality of tabs are coupled to the upper side of the first current collecting plate member in a first coupling region spaced from the first connection terminal in the lateral dimension, and wherein the second group of the plurality of tabs are coupled to the upper side of the second current collecting plate member in a second coupling region spaced from the second connection terminal in the lateral dimension.

18. A method of manufacturing a current collector for secondary batteries, comprising:
securing electrically conductive first and second current collecting plate members to a substrate formed of an electrically insulating material such that the first and second current collecting plate members are at least partially received in respective first and second recessed regions of the substrate and such that side edge surfaces of the first and second current collecting plate members in a thickness dimension thereof abut respective first and second side faces of the respective first and second recessed regions, the first and second recessed regions being spaced apart from one another in a lateral dimension of the substrate, and each of the first and second recessed regions being recessed downwardly in a vertical dimension from an upper side of the substrate so as to define the respective first and second side faces.

19. The method of claim 18, wherein the step of securing the first and second current collecting plate members to the substrate includes affixing the first and second current collecting plate members to the substrate by an adhesive.

20. The method according to claim 18, wherein the step of securing the first and second current collecting plate members to the substrate includes injection molding the electrically insulating material of the substrate within a mold in which the first and second current collecting plate members are received.
